(19) United States
(12) Patent Application Publication
(10) Pub. No.: US 2012/0168976 A1
(43) Pub. Date: Jul. 5, 2012

(54) MICROPOROUS POLYOLEFIN AND METHOD OF PRODUCING THE SAME

(75) Inventors: Mingjun Luo, Shenzhen (CN); Zhen You, Shenzhen (CN); Huiquan Liu, Shenzhen (CN)

(73) Assignee: BYD Co. Ltd., Shenzhen (CN)

(21) Appl. No.: 13/417,730

(22) Filed: Mar. 12, 2012

Related U.S. Application Data
(62) Division of application No. 12/603,950, filed on Oct. 22, 2009.

(30) Foreign Application Priority Data
Dec. 18, 2008 (CN) 200810241635.5

(51) Int. Cl. C08J 9/06

(52) U.S. Cl. 264/53

(57) ABSTRACT

A microporous film comprises a first component comprising a super high molecular weight polyolefin resin, wherein the weight-average molecular weight of the super high molecular weight polyolefin is about 1×10⁶ to about 6×10⁶. The microporous film also comprises a second component comprising a polyolefin resin, wherein the weight-average molecular weight of the polyolefin resin is less than about 5×10⁵. A method of producing a microporous film comprises melting a first polyolefin resin which is a super high molecular weight polyolefin resin in a solvent to form a first mixture, and adding to the first mixture a second polyolefin resin having a weight-average molecular weight of the less than about 5×105 to form a second mixture. The method also comprises forming the second mixture into a film, and removing the solvent from the film to form the microporous film

### CROSS REFERENCE TO RELATED APPLICATION

This application claims priority to Chinese Patent Application No. 200810241635.5, filed Dec. 18, 2008, the entirety of which is hereby incorporated by reference.

### FIELD

The present invention relates to microporous films and method of producing the same, and more particularly to microporous polyolefin films and method of producing the same.

### BACKGROUND

Microporous polyolefin films are thin-film-like material with microporous. They are widely used in the production of non-aqueous electrolyte battery separators, capacitor diaphragms, separation membranes, and water treatment films. The mechanical strength of existing microporous polyolefin films is poor, especially at high temperatures; the film breaking temperature is low; and they can easily cause potential safety problems.

The methods of producing microporous polyolefin films include both dry methods and wet methods. At present, the wet methods of producing microporous polyolefin films could only operate on low molecular weight polyolefin materials, or on low molecular weight polyolefin materials with a few super high molecular weight polyolefin added in. Because of the poor melt flowability and the slippery nature of the particle surface of the super high molecular weight polyolefin, if too much super high molecular weight polyolefin is added, the existing methods are easy to cause poor plasticizing, and result in only a small amount of super high molecular weight polyolefin to be plasticized, and thus the uniform microporous films can not be made at the end.

One parameter of the microporous polyolefin films is their mechanical strength, especially at high temperatures. The mechanical strength of the microporous polyolefin film directly impacts the safety and service life of electrical devices using the films. The mechanical strength properties of current microporous polyolefin films are qualified at room temperature. However, a main battery safety concern is its performance under abnormal conditions, such as at high temperatures. Thus it is necessary to enhance the high-temperature mechanical strength of microporous polyolefin films. Film breaking temperature is an important parameter related to the safety of the films at high temperatures, where the films with the higher film breaking temperature are safer.

### SUMMARY

In one aspect, a microporous film comprises a first component comprising a super high molecular weight polyolefin resin, wherein the weight-average molecular weight of the super high molecular weight polyolefin is about 1×10⁶ to about 6×10⁶. The microporous film also comprises a second component comprising a polyolefin resin, wherein the weight-average molecular weight of the polyolefin resin is less than about 5×10⁵.

In another aspect, a method of producing a microporous film comprises melting a first polyolefin resin which is a super high molecular weight polyolefin resin in a solvent to form a first mixture, and adding to the first mixture a second polyolefin resin having a weight-average molecular weight of the less than about 5×10⁵ to form a second mixture. The method also comprises forming the second mixture into a film, and removing the solvent from the film to form the microporous film.

In yet another aspect, a microporous film comprises a super high molecular weight polyolefin resin and a polyolefin resin, wherein the microporous polyolefin film has a film breaking temperature of about 150° C. to about 156° C., and a puncture strength at about 90° C. of about 428 g to about 533 g.

Other variations, embodiments and features of the present invention will become evident from the following detailed description, drawings and claims.

### DETAILED DESCRIPTION

It will be appreciated by those of ordinary skill in the art that the embodiments disclosed herein can be embodied in other specific forms without departing from the spirit or essential character thereof. The presently disclosed embodiments are therefore considered in all respects to be illustrative and not restrictive.

A microporous polyolefin film comprises a super high molecular weight polyolefin resin and a polyolefin resin. And the microporous polyolefin film has film breaking temperature of about 150° C. to about 156° C., and puncture strength at about 90° C. of about 428 g to about 533 g.

The super high molecular weight polyolefin resin and the polyolefin resin have a weight ratio of about 2:3 to about 4:1. In some embodiments, the weight ratio is from about 3:2 to about 3:1.

The super high molecular weight polyolefin resin includes one or more of single polymers or copolymers of the following monomers without limitation: ethylene, propylene, 1-butene, 4-methyl-1-pentene and 1-hexene. The weight-average molecular weight of the super high molecular weight polyolefin resins can be from about 1×10⁶ to about 6×10⁶. It may be difficult to melt and process if the weight-average molecular weight is more than about 6×10⁶. The mechanical strength can be too low if the weight-average molecular weight is less than about 1×10⁶. Preferably, the weight-average molecular weight of the super high molecular weight polyolefin can be from about 2×10⁶ to about 4×10⁶.

The polyolefin resin can be a high-density (about 0.94 to 0.96 kg/cm³) polyolefin resin which includes one or more of single polymers or copolymers of the following monomers without limitation: ethylene, propylene, 1-butene, 4-methyl-1-pentene and 1-hexene. The weight-average molecular weight of the polyolefin resin can be from about 1×10⁴ to about 5×10⁵. In some embodiments, it can be from about 5×10⁴ to about 3×10⁵.

In some embodiments, the polyolefin resin can further include a low-density (about 0.91 to 0.93 kg/cm³) polyolefin resin which includes one or more of single polymers or copolymers of the following monomers without limitation: ethylene, propylene, 1-butene, 4-methyl-1-pentene and 1-hexene. The low-density polyolefin resin can reduce the closed-cell temperature of polyolefin microporous films. The amount of low-density polyolefin resin can be about 0 to about 20% of the total polyolefin resin by weight.

A method of producing a microporous polyolefin film comprising:

(1) providing a first mixture by melting a super high molecular weight polyolefin resin and a solvent;

(2) providing a second mixture by melting the first mixture and a polyolefin resin;

(3) extruding the second mixture from die and molding into pieces by the cooling roller, drawing the pieces to form films;

(4) eluting the solvent from the films; and

(5) heating the films for setting.

The solvent can be one or more aliphatic hydrocarbons selected from the group consisting of nonane, decane, undecane, dodecane, decalin and liquid paraffin. In some embodiments, the solvent is liquid paraffin with a kinematical viscosity at about 40° C. of about 30 cst to 150 cst. This solvent can be easily melted with the super high molecular weight polyolefin, and can be easily eluted.

The super high molecular weight polyolefin resin and the solvent have a weight ratio of about 1:1.9 to about 1:6.7, wherein it can help to mold easily and obtain the microporous films with high porosity and high air permeability.

The melting technique can be any method known by one skilled in the art.

In one embodiment, the melting method in Step (1) can be as follows. First, the super high molecular weight polyolefin resin and solvent are mixed within a stirring tank under heating and pressure for a certain amount of time to allow them to swell fully, and then extruded by using a twin-screw extruder. In another embodiment, the melting method in Step (1) can be as follows. First, the super high molecular weight polyolefin resin is added to a twin-screw extruder, and the solvent is also added in from a lateral feed-port. Then the super high molecular weight polyolefin resin and the solvent are mixed and directly extruded by the twin-screw extruder. The melting temperature of the first mixture can be about from 230° C. to 240° C., which is about 40° C. to 100° C. above the melting point of the super high molecular weight polyolefin resin.

In some embodiments, the melting method in Step (2) can be as follows. The first mixture and polyolefin resin are added to the twin-screw extruder, and then mixed and directly extruded. The melting temperature can be about 40° C. to 100° C. above the melting point of the super high molecular weight polyolefin resin.

In the Step (3), the second mixture is extruded from the die of extruder and molded into pieces by a cooling roller. In order to prevent the formation of larger phase regions in the phase separation process, the polyolefin should be rapidly cooled after extrusion. The temperature of cooling roller can be below 30° C. The cooling rate can also be sped up using water bath, ice bath, ice salt bath, and the like.

The drawing can be either unidirectional or bidirectional. Preferably, the drawing is bidirectional. First, the drawing is along the machine direction (MD), and then along the transverse direction (TD). The total magnification can be about 10 to 100 times. If the drawing magnification is too small, the microporous films will have low porosity, poor air permeability and low intensity. If the drawing magnification is too large, the process will be difficult. The drawing temperature can be about 90° C. to 140° C.

In the Step (4), the elution solvent can be extraction agents of hydrocarbons, halogenated hydrocarbons, ethers and/or ketones. The hydrocarbons can be selected from pentane, hexane, heptane and decane. The halogenated hydrocarbons can be selected from chloromethane, carbon tetrachloride and trifluoroethane. The ethers can be selected from ether and dioxane. The ketones can be selected from acetone and butanone. The residual volume of solvent after elution is below 1 wt %.

In the Step (5), in order to prevent the high-temperature contraction, the microporous films need to be heat-treated. The films can be drawn along the transverse direction while heat treatment to ensure the microporous film has good permeability and mechanical strength. The drawing conditions include the preheating temperature of about 80° C. to 120° C., drawing temperature of about 100° C. to 130° C., heat-treatment temperature of about 110° C. to 140° C., heat-treatment time of about 10 s to 100 s, and drawing magnification of about 1.1 to 1.8 times.

The melting method of the present disclosure is a step by step melting. The super high molecular weight polyolefin resin is relatively more refractory, and has a good compatibility with solvent. The first melting step can make the super high molecular weight polyolefin resin plasticized fully, and form a homogeneous molten liquid. And then in the second melting step, the polyolefin resin can be easily dissolved, and mixed with the molten liquid above uniformly.

The melting method of the present disclosure can effectively solve the difficult problem of processing the super high molecular weight polyolefin microporous films, and enhance the mechanical strength of microporous polyolefin films, especially the mechanical strength at high temperatures.

### EXAMPLE 1

Take 20 kg of the super high molecular weight polyolefin resin UHMWPE (Ultra High Molecular Weight Polyethylene; weight-average molecular weight 3.0×10⁶, melting point 133° C.) and 80 kg of liquid paraffin (kinematical viscosity 90 cst at 40° C.) into the stirring tank heated at 200° C., stirring for 2 hours, and then take the mixed materials into a twin-screw extruder (diameter 78 mm, L/D=48, strong mixing type), under the conditions of 200° C. and 200 r/min for melting and mixing into a mixture. Extrude the mixture into another twin-screw extruder, at the same time put 5 kg of polyethylene resin (weight-average molecular weight 2.0×10⁵, melting point 133° C.), under the conditions of 200° C. and 220 r/min for mixing into a polyethylene solution.

Extrude the polyethylene solution through a T-type die (die gap degree of 1.2 mm, pieces of 260 mm) at the speed ratio of 3 m/min, and then mold it into pieces by a cooling roller, where the surface temperature of the cooling roller is about 15° C. and the thickness of the pieces is about 1.0 mm.

Bidirectionally draw the pieces step by step to form films. The drawing ratio is machine direction (MD)×transverse direction (TD)=5×7 times, wherein the MD drawing preheating temperature is 115° C.; the MD drawing temperature is 100° C.; the TD drawing preheating temperature is 125° C.; and TD drawing temperature is 110° C.

Elute the films obtained with heptane for 2 min, and then drying at 40° C. in a blast oven.

Heat-treat the films: first, preheat at the temperature of 100° C.; draw 1.5 times magnification at the temperature of 125° C.; and then heat the films to relax back to the drawing magnification of 1.3 times with the stereotype temperature of 125° C. for 20 seconds to obtain a polyolefin microporous film with a thickness of 20 μm.

The polyolefin microporous film produced is labeled A1.

### EXAMPLE 2

The steps are similar to those used in Example 1, with the difference being that the weight of the super high molecular weight polyolefin resin UHMWPE is 12 kg.

The polyolefin microporous film produced is labeled A2.

### EXAMPLE 3

The steps are similar to those used in Example 1, with the difference being that the weight of the super high molecular weight polyolefin resin UHMWPE is 30 kg.

The polyolefin microporous film produced is labeled A3.

### EXAMPLE 4

The steps are similar to those used in Example 1, with the difference being that the weight-average molecular weight of the super high molecular weight polyolefin resin UHMWPE is 5×10⁶, and the weight-average molecular weight of the polyethylene resin is 5×10⁴.

The polyolefin microporous film produced is labeled A4.

### EXAMPLE 5

The steps are similar to those used in Example 1, with the difference being that the weight-average molecular weight of the super high molecular weight polyolefin resin UHMWPE is 2×10⁶, and the weight-average molecular weight of the polyethylene resin is 3×10⁵.

The polyolefin microporous film produced is labeled A5.

### EXAMPLE 6

The steps are similar to those used in Example 1, with the difference being that the weight of liquid paraffin is 40 kg.

The polyolefin microporous film produced is labeled A6.

### REFERENCE 1

Take 5 kg of the super high molecular weight polyolefin resin UHMWPE (weight-average molecular weight 3.0×10⁶, melting point 133° C.), 80 kg of liquid paraffin (kinematical viscosity 90 cst at 40° C.) and 20 kg of polyethylene resin (weight-average molecular weight 2.0×10⁵, melting point 133° C.) into the stirring tank heated at 200° C., stirring for 2 hours, and then take the mixed materials into the twin-screw extruder (diameter 78 mm, L/D=48, strong mixing type), under the conditions of 200° C. and 200 r/min for melting and mixing into a polyethylene solution.

The subsequent steps are similar to those used in Example 1, and the polyolefin microporous film produced is labeled RC1.

### TESTING

(1) Air Permeability

Test according to standard JIS P8117, and the results are shown in Table 1.

(2) Puncture Strength

Respectively record the maximum loads of using a needle with diameter of 1 mm in speed of 2 mm/s to puncture the microporous polyolefin films at room temperature and 90° C. The results are shown in Table 1.

(3) Film Breaking Temperature

Prepare a box board with the internal dimensions of a×b=4 cm×3 cm. Fix microporous polyolefin film into the box, where the MD direction of the microporous polyolefin film is along the a-side of the box board. Then maintain 10 min at the temperature of 145° C. to confirm whether the film ruptures. If there is no rupture of film, increase 1° C. each time to maintain the film for another 10 min. Once the film ruptures, record the temperature as its film breaking temperature. The results are shown in Table 1.

(4) Shrinkage Rate

Record the shrinkage rate of microporous polyolefin films baked for 1 hour at 120° C. according to standard GB12027-1989. The results are shown in Table 1.

TABLE 1
Table 1. Testing Results For Microporous Polyolefin Films

| | Air | Puncture Strength | Puncture | Film Breaking | Shrinkage | |
|---|---|---|---|---|---|---|
| | Permeability | (g)/Room | Strength | Temperature | Rate/120° C. | |
| | (s/100 cc) | Temperature | (g)/90° C. | (° C.) | MD % | TD % |
| A1 | 358 | 620 | 529 | 154 | 15.2 | 14.4 |
| A2 | 380 | 602 | 485 | 152 | 15.6 | 14.0 |
| A3 | 335 | 556 | 428 | 151 | 16.0 | 14.8 |
| A4 | 348 | 650 | 533 | 156 | 15.9 | 15.0 |
| A5 | 350 | 622 | 503 | 154 | 15.0 | 14.4 |
| A6 | 520 | 522 | 460 | 156 | 13.8 | 13.4 |
| RC1 | 323 | 480 | 338 | 146 | 16.4 | 15.5 |

From Table 1, it can be observed that adding the super high molecular weight polyolefin resin can increase the high-temperature puncture strength and film breaking temperature of polyolefin microporous films. The more amount added and the higher molecular weight of the super high molecular weight polyolefin resin, the higher puncture strength and higher film breaking temperature the films have, as well as the better safety of the products.

Although the present disclosure has been described in detail with reference to several embodiments, additional variations and modifications exist within the scope and spirit as described and defined in the following claims.

1-12. (canceled)

13. A method of producing a microporous film comprising:
melting a first polyolefin resin which is a super high molecular weight polyolefin resin in a solvent to form a first mixture;
adding to the first mixture a second polyolefin resin having a weight-average molecular weight of the less than about 5×10⁵ to form a second mixture;
forming the second mixture into a film; and
removing the solvent from the film to form the microporous film.

14. The method of claim 13, wherein the forming step is accomplished by a method selected from the group consisting of extruding, molding, drawing, and combinations thereof.

15. The method of claim 13, further comprising annealing the microporous film after removing the solvent.

16. The method of claim 13, wherein the solvent is liquid paraffin, and the kinematical viscosity of the liquid paraffin at about 40° C. is about 30 cst to 150 cst.

17. The method of claim 14, wherein the drawing comprises a first drawing along the machine direction, and then a second drawing along the transverse direction.

18. The method of claim 13, wherein the melting temperature of the first mixture is about 230° C. to 240° C.

19. The method of claim 13, wherein the first polyolefin resin and the solvent have a weight ratio of about 1:1.9 to about 1:6.7.

20. (canceled)

21. The method of claim 13, wherein the first polyolefin resin and the second polyolefin resin have a weight ratio of about 2:3 to about 4:1.

22. The method of claim 21, wherein the first polyolefin resin and the second polyolefin resin have a weight ratio of about 3:2 to about 3:1.

23. The method of claim 13, wherein the weight-average molecular weight of the first polyolefin resin is about 2×10⁶ to about 4×10⁶.

24. The method of claim 13, wherein the weight-average molecular weight of the second polyolefin resin is about 5×10⁴ to about 3×10⁵.

25. The method of claim 13, wherein the first polyolefin resin comprises a polymer formed from a monomer selected from the group consisting of ethylene, propylene, 1-butene, 4-methyl-1-pentene, 1-hexene, and combinations thereof.

26. The method of claim 13, wherein the second polyolefin resin comprises a high-density polyolefin resin, wherein the high-density polyolefin resin comprises a polymer formed from a monomer selected from the group consisting of ethylene, propylene, 1-butene, 4-methyl-1-pentene, 1-hexene, and combinations thereof.

27. The method of claim 26, wherein the second polyolefin resin further comprises a low-density polyolefin resin.

28. The method of claim 27, wherein the low-density polyolefin resin comprises a polymer formed from a monomer selected from the group consisting of ethylene, propylene, 1-butene, 4-methyl-1-pentene, 1-hexene, and combinations thereof.

29. The method of claim 27, wherein the amount of the low-density polyolefin resin is 0 to about 20% of the total of the second polyolefin resin by weight.

30. The method of claim 13, wherein the microporous film has a film breaking temperature of about 150° C. to about 156° C.

31. The method of claim 13, wherein the microporous film has a puncture strength at about 90° C. of about 428 g to about 533 g.
